(19) United States
(12) Patent Application Publication
(10) Pub. No.: US 2020/0193821 A1
(43) Pub. Date: Jun. 18, 2020

(54) CONTROL DEVICE FOR VEHICLE AND AUTOMATIC DRIVING SYSTEM

(71) Applicant: Toyota Jidosha Kabushiki Kaisha, Toyota-shi Aichi-ken (JP)

(72) Inventors: Makoto Kawaharada, Sunto-gun (JP); Katsuhiro Sakai, Hadano-shi (JP); Akihide Tachibana, Susono-shi (JP); Tomoyuki Kuriyama, Hadano-shi (JP)

(73) Assignee: Toyota Jidosha Kabushiki Kaisha, Toyota-shi Aichi-ken (JP)

(21) Appl. No.: 16/599,577

(22) Filed: Oct. 11, 2019

(30) Foreign Application Priority Data
Dec. 12, 2018 (JP) 2018-232882

(51) Int. Cl. G08G 1/0967; G05D 1/00; B60W 30/18

(52) U.S. Cl. CPC G08G 1/096725; G05D 1/0088; B60W 30/18; G05D 2201/0213; B60W 2550/22; B60W 2550/40; B60W 2720/106

(57) ABSTRACT

A control device for a vehicle includes: a signal information acquisition unit that acquires signal information about at least one traffic light, from a server having signal information about a plurality of traffic lights provided at a plurality of intersections; and a vehicle control unit that controls the vehicle, based on the signal information acquired by the signal information acquisition unit.

### CROSS-REFERENCE TO RELATED APPLICATIONS

This application claims priority to Japanese Patent Application No. 2018-232882 filed on Dec. 12, 2018, which is incorporated herein by reference in its entirety including the specification, drawings and abstract.

### BACKGROUND

### 1. Technical Field

The present disclosure relates to a control device for a vehicle and an automatic driving system.

### 2. Description of Related Art

In recent years, a vehicle that can perform autonomous traveling has been developed. In the vehicle that can perform autonomous traveling, it is necessary that the vehicle itself discriminates a lighting state of a traffic light instead of a driver. In this regard, Japanese Patent Application Publication No. 2010-134851 describes that signal information about the traffic light is acquired from a roadside unit by road-vehicle communication.

### SUMMARY

However, in the case of occurrence of communication disturbance or the like, there is concern that the signal information cannot be acquired from the roadside unit. Further, all traffic lights are not provided with the roadside unit that can send the signal information. Therefore, the technique for acquiring the signal information about the traffic light has room for improvement.

In view of the above problem, an object of the present disclosure is to reliably acquire the signal information about the traffic light in the case of the autonomous driving of the vehicle.

The spirit of the disclosure is shown as follows.

(1) A control device for a vehicle, the vehicle performing autonomous traveling, the control device including: a signal information acquisition unit that acquires signal information about at least one traffic light, from a server having signal information about a plurality of traffic lights provided at a plurality of intersections; and a vehicle control unit that controls the vehicle, based on the signal information acquired by the signal information acquisition unit.

(2) The control device for the vehicle according to the above (1), in which the signal information acquisition unit sends a position of the vehicle and a movement direction of the vehicle, to the server, and acquires signal information about a traffic light that is positioned forward of the vehicle and that is closest to the vehicle, from the server.

(3) The control device for the vehicle according to the above (1) or (2), in which the signal information acquisition unit acquires future signal information about at least one traffic light, from the server.

(4) The control device for the vehicle according to any one of the above (1) to (3), in which the signal information acquisition unit acquires signal information about a plurality of traffic lights, from the server.

(5) The control device for the vehicle according to the above (3) or (4), in which: the signal information acquisition unit acquires future signal information about a plurality of traffic lights on a traveling route of the vehicle, from the server; and the vehicle control unit controls a speed of the vehicle, based on the future signal information about the plurality of traffic lights.

(6) The control device for the vehicle according to the above (3) or (4), in which: the signal information acquisition unit acquires future signal information about a plurality of traffic lights for each of which a distance from the vehicle is equal to or less than a predetermined value, from the server; and the vehicle control unit resets a traveling route of the vehicle, based on the future signal information about the plurality of traffic lights.

(7) The control device for the vehicle according to any one of the above (1) to (6), in which: the signal information acquisition unit acquires signal information about a traffic light from a roadside unit by road-vehicle communication; and when the signal information acquisition unit fails to acquire the signal information from the roadside unit, the vehicle control unit controls the vehicle, based on the signal information acquired from the server by the signal information acquisition unit.

(8) The control device for the vehicle according to any one of the above (1) to (6), in which: the signal information acquisition unit acquires signal information about a traffic light from a roadside unit by road-vehicle communication; and when the signal information acquisition unit fails to acquire the signal information from the server, the vehicle control unit controls the vehicle, based on the signal information acquired from the roadside unit by the signal information acquisition unit.

(9) An automatic driving system including: a server that acquires signal information about a plurality of traffic lights provided at a plurality of intersections; a signal information acquisition unit that acquires signal information about at least one traffic light, from the server; and a vehicle control unit that controls a vehicle, based on the signal information acquired by the signal information acquisition unit.

(10) The automatic driving system according to the above (9), in which the server acquires the signal information about the plurality of traffic lights, from a traffic control center that generates control information about traffic lights.

(11) The automatic driving system according to the above (9) or (10), in which the server acquires the signal information about the plurality of traffic lights, from traffic light images that are generated by cameras.

(12) The automatic driving system according to the above (9) to (11), in which the server acquires the signal information about the plurality of traffic lights, from controllers or lighting state detectors, each of the controllers controlling a lighting state of the traffic light, each of the lighting state detectors detecting the lighting state of the traffic light from a signal line between the traffic light and the controller.

With the present disclosure, it is possible to reliably acquire the signal information about the traffic light in the case of the autonomous driving of the vehicle.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a schematic configuration diagram of an automatic driving system according to a first embodiment of the present disclosure;

FIG. 2 is a diagram schematically showing a configuration of a vehicle;

FIG. 3 is a functional block diagram of an ECU of the vehicle according to the first embodiment;

FIG. 4 is a flowchart showing a control routine of a vehicle control in the first embodiment;

FIG. 5 is a diagram schematically showing a situation at an intersection in a second embodiment;

FIG. 6 is a flowchart showing a control routine of a vehicle control in the second embodiment; and

FIG. 7 is a diagram schematically showing a situation at an intersection in a third embodiment.

### DETAILED DESCRIPTION OF EMBODIMENTS

Hereinafter, embodiments of the present disclosure will be described with reference to the drawings. In the following description, similar constituent elements are denoted by identical reference numerals.

### First Embodiment

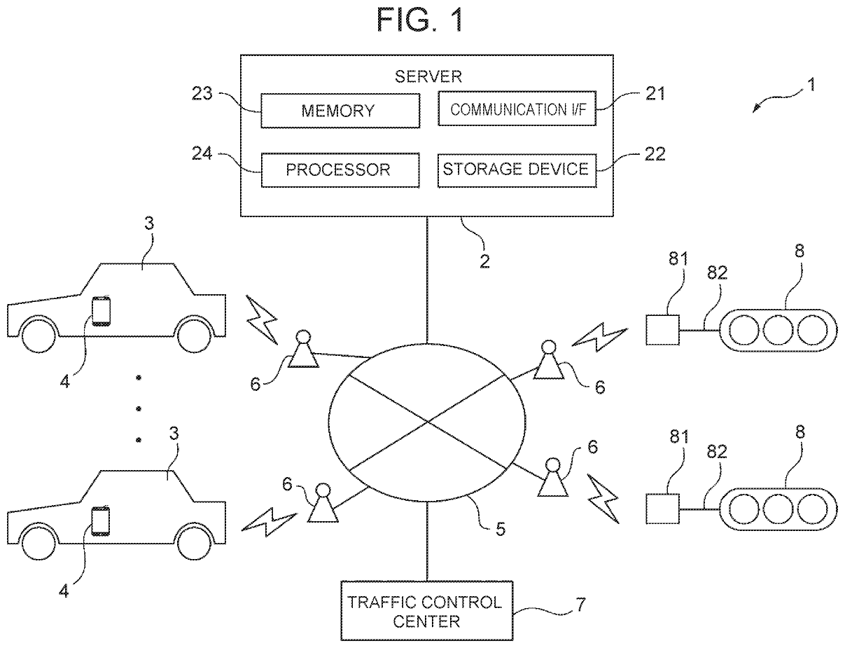

A first embodiment of the present disclosure will be described below, with reference to FIG. 1 to FIG. 4. FIG. 1 is a schematic configuration diagram of an automatic driving system according to the first embodiment of the present disclosure. An automatic driving system 1 assists autonomous traveling of a vehicle 3, using a server 2.

The automatic driving system 1 includes the server 2 and the vehicle 3. The server 2 is provided in the exterior of the vehicle 3, and the server 2 and the vehicle 3 can communicate with each other.

The vehicle 3 is configured to perform autonomous traveling. Accordingly, the vehicle 3 is a so-called automatic driving vehicle, and does not require a driver who operates the vehicle 3. The vehicle 3 may be configured to make an occupant of the vehicle 3 operate the vehicle 3 at the time of an emergency.

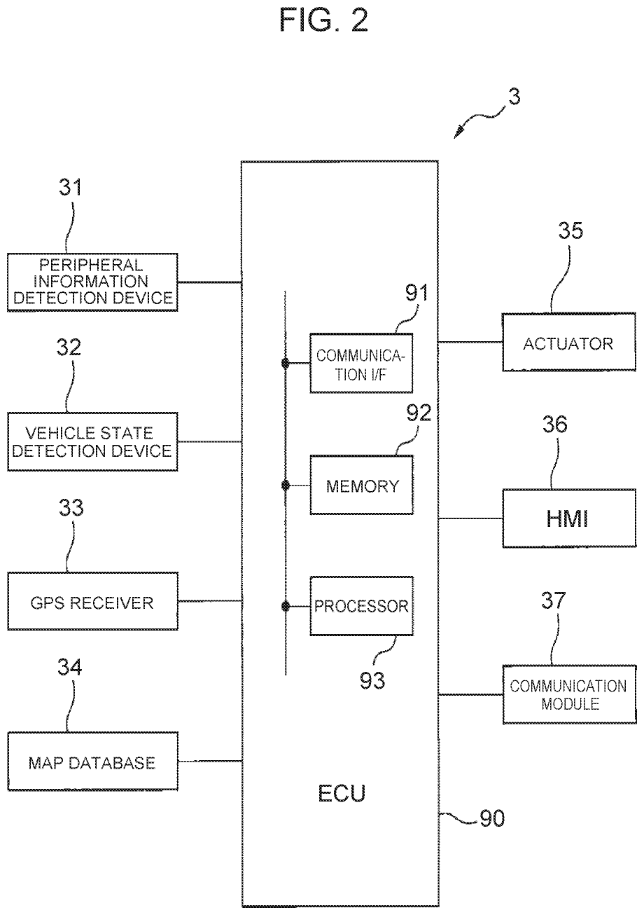

FIG. 2 is a diagram schematically a configuration of the vehicle 3. The vehicle 3 includes an electronic control unit (ECU) 90. The ECU 90 includes a communication interface 91, a memory 92 and a processor 93, and executes a variety of controls for the vehicle 3. The communication interface 91 and the memory 92 are connected to the processor 93 through a signal line. The ECU 90 is an exemplary control device for the vehicle 3. In the embodiment, a single ECU 90 is provided, but a plurality of ECUs each of which has respective functions may be provided.

The communication interface 91 includes an interface circuit for connecting the ECU 90 to an in-vehicle network that complies with a standard such as a controller area network (CAN). The ECU 90 communicates with another in-vehicle device through the communication interface 91.

For example, the memory 92 includes a volatile semiconductor memory (for example, a RAM) and a non-volatile semiconductor memory (for example, a ROM). In the memory 92, programs to be executed by the processor 93, a variety of data to be used when a variety of processes are executed by the processor 93, and the like are stored.

The processor 93 includes a single central processing unit (CPU) or a plurality of CPUs, and CPU peripheral circuits, and executes a variety of processes. The processor 93 may further include an arithmetic circuit such as an arithmetic-logic unit or a numerical operation unit.

Further, the vehicle 3 includes a peripheral information detection device 31. The peripheral information detection device 31 detects peripheral information about the vehicle 3, for the autonomous traveling of the vehicle 3. The peripheral information includes information about white lines on the road, other vehicles, pedestrians, bicycles, buildings, traffic signs, traffic lights and obstacles. The peripheral information detection device 31 is connected to the ECU 90 through the in-vehicle network, and an output of the peripheral information detection device 31 is sent to the ECU 90. For example, the peripheral information detection device 31 includes an exterior camera, a millimeter-wave radar, a LIDAR (Laser Imaging Detection and Ranging), an ultrasonic sensor, and the like.

Further, the vehicle 3 includes a vehicle state detection device 32. The vehicle state detection device 32 detects a lighting state of the vehicle 3, for the autonomous traveling of the vehicle 3. The vehicle state detection device 32 is connected to the ECU 90 through the in-vehicle network, and an output of the vehicle state detection device 32 is sent to the ECU 90. For example, the vehicle state detection device 32 includes a speed sensor, a yaw rate sensor, and the like. The speed sensor detects the speed of the vehicle 3. The yaw rate sensor detects a yaw rate that is a rotational speed about a vertical axis passing through the center of gravity of the vehicle 3.

Further, the vehicle 3 includes a GPS receiver 33. The GPS receiver 33 receives signals from three or more GPS satellites, and detects the current position of the vehicle 3 (for example, the latitude and longitude of the vehicle 3). The GPS receiver 33 is connected to the ECU 90 through the in-vehicle network, and an output of the GPS receiver 33 is sent to the ECU 90.

Further, the vehicle 3 includes a map database 34. In the map database 34, map information is stored. The map database 34 is connected to the ECU 90 through the in-vehicle network, and the ECU 90 acquires the map information from the map database 34. The map information stored in the map database 34 is updated using data received from the exterior of the vehicle 3, a simultaneous localization and mapping (SLAM) technology, or the like.

Further, the vehicle 3 includes an actuator 35. The actuator 35 actuates the vehicle 3. The actuator 35 is connected to the ECU 90 through the in-vehicle network, and the ECU 90 controls the actuator 35. For example, the actuator 35 includes a drive device (at least one of an engine and a motor) for accelerating the vehicle 3, a brake actuator for braking the vehicle 3, a steering motor for steering the vehicle 3, and the like.

Further, the vehicle 3 includes a human machine interface (HMI) 36. The HMI 36 is an input-output device that performs input and output of information between the occupant of the vehicle 3 and the vehicle 3. For example, the HMI 36 includes a display that displays information, a speaker that generates sound, an operation button or a touch screen for an input operation by the occupant, a microphone that receives a voice of the occupant, and the like. To the occupant of the vehicle 3, the HMI 36 provides information (the current position of the vehicle 3, weather, ambient temperature, and the like) and entertainment (music, movies, TV programs, games and the like). The HMI 36 is connected to the ECU 90 through the in-vehicle network. An output of the ECU 90 is transferred to the occupant through the HMI 36, and an input from the occupant is sent to the ECU 90 through the HMI 36.

Further, the vehicle 3 includes a communication module 37. The communication module 37 is a device that allows communication between the vehicle 3 and the exterior of the vehicle 3. For example, the communication module 37 includes a data communication module (DCM) and a short-range wireless communication module (for example, a WiFi module, Bluetooth (R) module and the like). The vehicle 3 communicates with the server 2, through the data communication module, a wireless base station 6 and a communication network 5. The vehicle 3 communicates with a mobile terminal 4 (see FIG. 1) of the occupant of the vehicle 3, a roadside unit, another vehicle, and the like, through the short-range wireless communication module.

As shown in FIG. 1, the server 2 includes a communication interface 21, a storage device 22, a memory 23 and a processor 24. The communication interface 21, the storage device 22 and the memory 23 are connected to the processor 24 through a signal line. The server 2 may further include an input device such as a keyboard and a mouse, an output device such as a display, and the like. The server 2 may be constituted by a plurality of computers.

The communication interface 21 includes an interface circuit for connecting the server 2 to the communication network 5. The server 2 communicates with the vehicle 3 through the communication interface 21, the communication network 5 and a wireless base station 6.

For example, the storage device 22 includes a hard disk drive (HDD), a solid state drive (SSD) or an optical recording medium. In the storage device 22, a variety of data is stored, and for example, vehicle information, map information, traffic light information, and computer programs by which the processor 24 executes a variety of processes are stored. The computer programs may be recorded in a recording medium such as an optical recording medium or a magnetic recording medium, to be distributed.

For example, the memory 23 includes a semiconductor memory such as a random access memory (RAM). In the memory 23, for example, a variety of data to be used when the processor 24 executes a variety of processes is stored.

The processor 24 includes a single CPU or a plurality of CPUs, and CPU peripheral circuits, and executes a variety of processes. The processor 24 may further include an arithmetic circuit such as an arithmetic-logic unit or a numerical operation unit.

In the vehicle 3 that can perform autonomous traveling, it is necessary that the vehicle 3 itself discriminates a lighting state of a traffic light 8 instead of a driver. For example, it is possible that signal information about the traffic light 8 is acquired by road-vehicle communication between a roadside unit provided at each intersection and the vehicle 3. However, in the case of occurrence of communication disturbance or the like, there is concern that the signal information cannot be acquired from the roadside unit. Further, all traffic lights 8 are not provided with the roadside unit that can send the signal information.

Hence, in the embodiment, the signal information (the lighting state of the traffic light 8 and the like) about the traffic light 8 is acquired from the server 2 having the signal information about a plurality of traffic lights 8 provided at a plurality of intersections. Thereby, it is possible to acquire the signal information at a desired timing, regardless of whether the roadside unit is provided, and therefore, it is possible to reliably acquire the signal information about the traffic light 8 in the case of the autonomous driving of the vehicle 3.

In the embodiment, a traffic control center 7 generates control information about the traffic light 8, and sends the control information to a controller 81. Specifically, the traffic control center 7 generates the control information about the traffic light 8, based on traffic information and the like that are collected by the traffic control center 7, and sends the control information to the controller 81 through the communication network 5 and the wireless base station 6. For example, the controller 81 is provided at each intersection, and is connected to the traffic light 8 through the signal line 82. The controller 81 controls the lighting state of the traffic light 8 provided at the intersection, based on the control information sent from the traffic control center 7.

The server 2 acquires the signal information about the plurality of traffic lights 8 from the traffic control center 7. Specifically, the server 2 communicates with the traffic control center 7 through the communication network 5, and receives the signal information about the plurality of traffic lights 8 from the traffic control center 7. Thereby, the server 2 can quickly acquire the accurate signal information.

The server 2 may communicates with the traffic control center 7 through a dedicated communication line, instead of the communication network 5. The server 2 may be provided in the traffic control center 7.

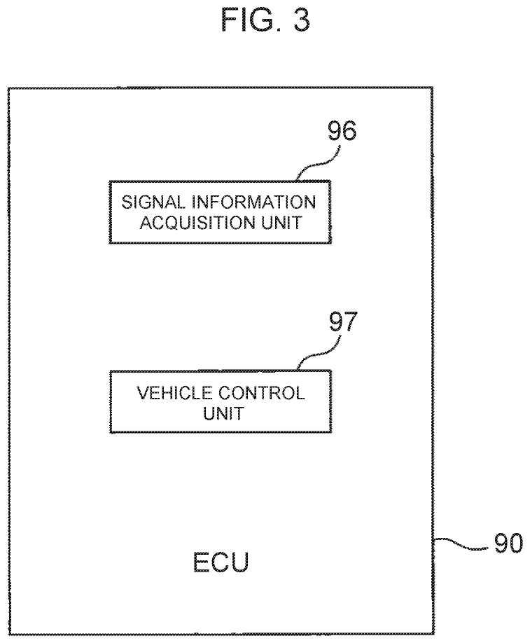

FIG. 3 is a functional block diagram of the ECU 90 of the vehicle 3 in the first embodiment. In the embodiment, the ECU 90 includes a signal information acquisition unit 96 and a vehicle control unit 97. The signal information acquisition unit 96 and the vehicle control unit 97 are functional blocks to be realized when the processor 93 of the ECU 90 executes programs stored in the memory 92 of the ECU 90.

The signal information acquisition unit 96 acquires the signal information about at least one traffic light 8, from the server 2. Specifically, the signal information acquisition unit 96 receives the signal information about at least one traffic light 8 from the server 2 through the communication network 5, the wireless base station 6 and the communication module 37. The server 2 may send the signal information about at least one traffic light 8, to the mobile terminal 4 of the occupant of the vehicle 3, through the communication network 5 and the wireless base station 6, and the signal information acquisition unit 96 may receive the signal information about the at least one traffic light 8 from the server 2 through the mobile terminal 4.

The vehicle control unit 97 controls the vehicle 3, based on the signal information acquired by the signal information acquisition unit 96. For example, using the actuator 35, the vehicle control unit 97 controls the vehicle 3 so as to observe traffic regulations, based on the signal information acquired by the signal information acquisition unit 96.

Vehicle Control

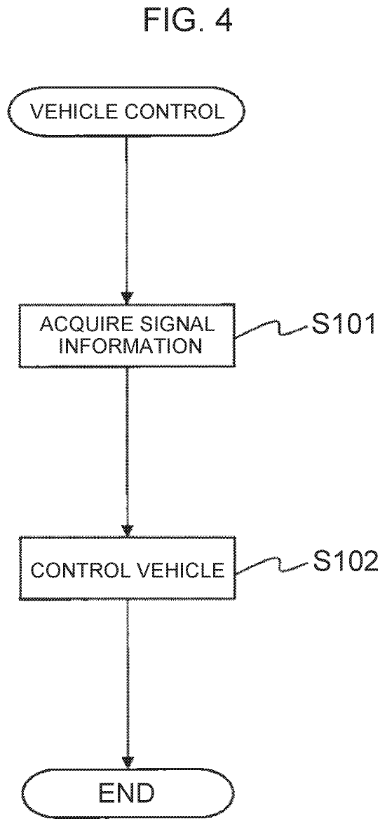

A vehicle control using the signal information about the traffic light will be described below in detail, with reference to FIG. 4. FIG. 4 is a flowchart showing a control routine of the vehicle control in the first embodiment. The control routine is executed repeatedly by the ECU 90.

First, in step S101, the signal information acquisition unit 96 acquires the signal information about at least one traffic light, from the server 2. For example, the signal information acquisition unit 96 acquires the signal information about at least one traffic light including a traffic light (hereinafter, referred to as a “forward traffic light”) that is positioned forward of the vehicle 3 and that is closest to the vehicle 3, from the server 2. In this case, the signal information acquisition unit 96 sends the position and movement direction of the vehicle 3, to the server 2, and acquires the signal information about the forward traffic light, from the server 2.

The position of the vehicle 3 is detected by the GPS receiver 33. The movement direction of the vehicle 3 is detected from a change in the position of the vehicle 3 that is detected by the GPS receiver 33. The movement direction of the vehicle 3 may be detected from a traveling path of the vehicle 3 that is previously generated by the vehicle control unit 97.

Since the signal information acquisition unit 96 sends the position and movement direction of the vehicle 3 to the server 2, the server 2 can easily identify the forward traffic light, based on the position and movement direction of the vehicle 3. As a result, the signal information acquisition unit 96 can quickly acquire the signal information about the forward traffic light.

The signal information acquisition unit 96 may send the peripheral information about the vehicle 3 that is detected by the peripheral information detection device 31, to the server 2, and the server 2 may identify the forward traffic light based on the peripheral information about the vehicle 3. The signal information acquisition unit 96 may send identification information about the forward traffic light, to the server 2, and the server 2 may send the signal information about the traffic light corresponding to the identification information, to the vehicle 3.

Next, in step S102, the vehicle control unit 97 controls the vehicle 3, based on the signal information acquired by the signal information acquisition unit 96. For example, in the case where the lighting state of the forward traffic light is green, the vehicle control unit 97 controls the vehicle 3 such that the vehicle 3 passes through the forward traffic light. On the other hand, in the case where the lighting state of the forward traffic light is red, the vehicle control unit 97 controls the vehicle 3 such that the vehicle 3 stops at the forward traffic light. After step S102, the control routine ends.

In step S101, the signal information acquisition unit 96 may acquire future signal information about at least one traffic light, from the server 2, and in step S102, the vehicle control unit 97 may control the vehicle 3 based on the future signal information about at least one traffic light. Thereby, it is possible to realize an efficient control of the vehicle 3 in consideration of the future lighting state of the traffic light.

In this case, the server 2 acquires a schedule of control of each traffic light, from the traffic control center, and estimate the future signal information about a predetermined traffic light, based on the schedule. The server 2 may store the past signal information about the traffic light, and may estimate the future signal information about the traffic light, from the current signal information about the traffic light, based on the past signal information about the traffic light.

For example, the signal information acquisition unit 96 acquires the signal information about the forward traffic light when the vehicle 3 arrives at the forward traffic light, from the server 2. In this case, the signal information acquisition unit 96 sends the current position, movement direction and speed of the vehicle 3, to the server 2, and the server 2 identifies the forward traffic light and the arrival time of the vehicle 3 at the forward traffic light, based on the current position, movement direction and speed of the vehicle 3, and sends the signal information about the forward traffic light at the arrival time, to the vehicle 3. The speed of the vehicle 3 is detected by the sped sensor of the vehicle state detection device 32.

For example, in the case where the lighting state of the forward traffic light when the vehicle 3 arrives at the forward traffic light is green, the vehicle control unit 97 maintains the speed of the vehicle 3, and in the case where the lighting state of the forward traffic light when the vehicle 3 arrives at the forward traffic light is red, the vehicle control unit 97 gradually decreases the speed of the vehicle 3. Thereby, it is possible to reduce the amount of fuel consumption or electricity consumption by the vehicle 3.

The signal information acquisition unit 96 may acquire the signal information about the forward traffic light from the current time to a predetermined time, from the server 2, and the vehicle control unit 97 may control the vehicle 3 such that the vehicle 3 passes through the forward traffic light when the lighting state of the forward traffic light is green or yellow. Thereby, it is possible to reduce the amount of fuel consumption or electricity consumption by the vehicle 3, and it is possible to shorten the time before the vehicle 3 arrives at a destination. Instead of the forward traffic light or in addition to the forward traffic light, the signal information acquisition unit 96 may acquire the future signal information about a traffic light other than the forward traffic light, from the server 2.

In step S101, the signal information acquisition unit 96 may acquire the signal information about a plurality of traffic lights, from the server 2, and in step S102, the vehicle control unit 97 may control the vehicle 3 based on the signal information about the plurality of traffic lights. Thereby, it is possible to realize an efficient control of the vehicle 3 in consideration of the lighting states of the plurality of traffic lights.

For example, the signal information acquisition unit 96 acquires the future signal information about a plurality of traffic lights on a traveling route of the vehicle 3, from the server 2. In this case, the signal information acquisition unit 96 sends information indicating a traveling route previously generated by the vehicle control unit 97, to the server 2, and the server 2 identifies a plurality of traffic lights on the traveling route. The vehicle control unit 97 controls the speed of the vehicle 3, based on the future signal information about the plurality of traffic lights on the traveling route of the vehicle 3. For example, the vehicle control unit 97 controls the speed of the vehicle 3, so as to decrease the number of stops of the vehicle 3 at traffic lights. Thereby, it is possible to reduce the amount of fuel consumption or electricity consumption by the vehicle 3, and it is possible to shorten the time before the vehicle 3 arrives at the destination.

The signal information acquisition unit 96 may acquire the current signal information about a plurality of traffic lights (for example, two traffic lights forward of the vehicle 3) on the traveling route of the vehicle 3, from the server 2, and the vehicle control unit 97 may control the speed of the vehicle 3, based on the current signal information about the plurality of traffic lights on the traveling route of the vehicle 3. In this case, for example, the vehicle control unit 97 gradually decreases the speed of the vehicle 3, from a position a predetermined distance before a traffic light at which the vehicle 3 is likely to need to stop. Thereby, it is possible to reduce the amount of fuel consumption or electricity consumption by the vehicle 3.

The signal information acquisition unit 96 may acquire the future signal information about a plurality of traffic lights (hereinafter, referred to as “peripheral traffic lights”) for each of which the distance from the vehicle 3 is equal to or less than a predetermined value, from the server 2. In this case, the signal information acquisition unit 96 sends the current position of the vehicle 3, to the server 2, and the server 2 identifies the peripheral traffic lights based on the current position of the vehicle 3. The vehicle control unit 97 resets the traveling route of the vehicle 3, based on the future signal information about the peripheral traffic lights, and causes the vehicle 3 to travel along the traveling route after the reset. For example, the vehicle control unit 97 resets the traveling route of the vehicle 3, so as to shorten the time before the vehicle 3 arrives at the destination. Thereby, it is possible to shorten the time before the vehicle 3 arrives at the destination.

### Second Embodiment

The configuration and control of a control device for a vehicle and an automatic driving system according to a second embodiment are basically the same as the configuration and control in the first embodiment, except the following description. Therefore, for the second embodiment of the present disclosure, differences from the first embodiment will be mainly described below.

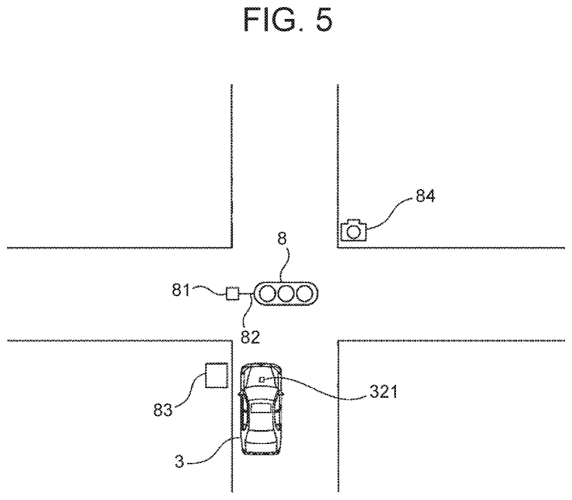

FIG. 5 is a diagram schematically showing a situation at an intersection in the second embodiment. In the second embodiment, the signal information acquisition unit 96 acquires the signal information about the traffic light 8 from a roadside unit 83 by road-vehicle communication, in addition to the server 2. Thereby, it is possible to secure a plurality of methods and systems for acquiring the signal information about the traffic light 8, and it is possible to more reliably acquire the signal information about the traffic light 8.

Specifically, when the distance between the vehicle 3 and the roadside unit 83 is in a predetermined range, the signal information acquisition unit 96 receives the signal information about the traffic light 8 from the roadside unit 83, by the road-vehicle communication using the communication module 37. In the road-vehicle communication, a short-range wireless communication using a predetermined bandwidth (for example, 760 MHz) is performed. The roadside unit 83 is provided at each intersection, and receives the signal information about the traffic light 8 provided at the intersection, from the controller 81 or the traffic control center 7. Therefore, the roadside unit 83 has the signal information about the traffic light 8.

In the case where the signal information acquisition unit 96 fails to acquire the signal information from the roadside unit 83, the vehicle control unit 97 controls the vehicle 3, based on the signal information acquired from the server 2 by the signal information acquisition unit 96. Thereby, even when the communication with the roadside unit 83 is disturbed or even when the roadside unit 83 having the signal information does not exist, it is possible to acquire the signal information from the server 2.

In the second embodiment, the server 2 acquires the signal information about a plurality of traffic lights 8, from traffic light images that are generated by cameras, instead of the traffic control center 7. Thereby, even when the traffic control center 7 does not perform the central control of the traffic lights 8, it is possible to acquire the signal information about the traffic lights 8.

For example, the camera that generates the traffic light image is a fixed camera 84 that is provided near the traffic light 8 so as to photograph the traffic light 8. For example, the fixed camera 84 is provided at each intersection. The fixed camera 84 includes a transceiver, and can communicate with the server 2. The fixed camera 84 sends identification information about the fixed camera 84 and the traffic light image to the server 2 through the wireless base station 6 and the communication network 5, at a predetermined interval. The server 2 identifies the position of the traffic light 8 from the identification information about the fixed camera 84, and acquires the signal information about the traffic light 8 from the traffic light image, by analyzing the traffic light image. In the analysis of the traffic light image, for example, a technique such as machine learning using a neural network is used.

The camera that generates the traffic light image may be an exterior camera 321 that is provided on the vehicle 3 so as to photograph a forward view of the vehicle 3. In this case, each of a plurality of vehicles 3 sends the position of the vehicle 3 at the time of photographing and the photographed image to the server 2 through the wireless base station 6 and the communication network 5, at a predetermined interval. The server 2, first, extracts the traffic light image from the photographed image, by analyzing the photographed image. Thereafter, the server 2 identifies the position of the traffic light 8, from the position of the vehicle 3 at the time of photographing, and acquires the signal information about the traffic light 8 from the traffic light image, by analyzing the traffic light image. The traffic light image may be extracted from the photographed image by the vehicle 3, and only the traffic light image may be sent from the vehicle 3 to the server 2. In the analysis of the photographed image and the traffic light image, for example, a technique such as machine learning using a neural network is used.

The camera that generates the traffic light image may be constituted by the fixed camera 84 and the exterior camera 321. That is, the server 2 may acquire the signal information about a plurality of traffic lights 8, from traffic light images generated by fixed cameras 84 and traffic light images generated by exterior cameras 321.

Vehicle Control

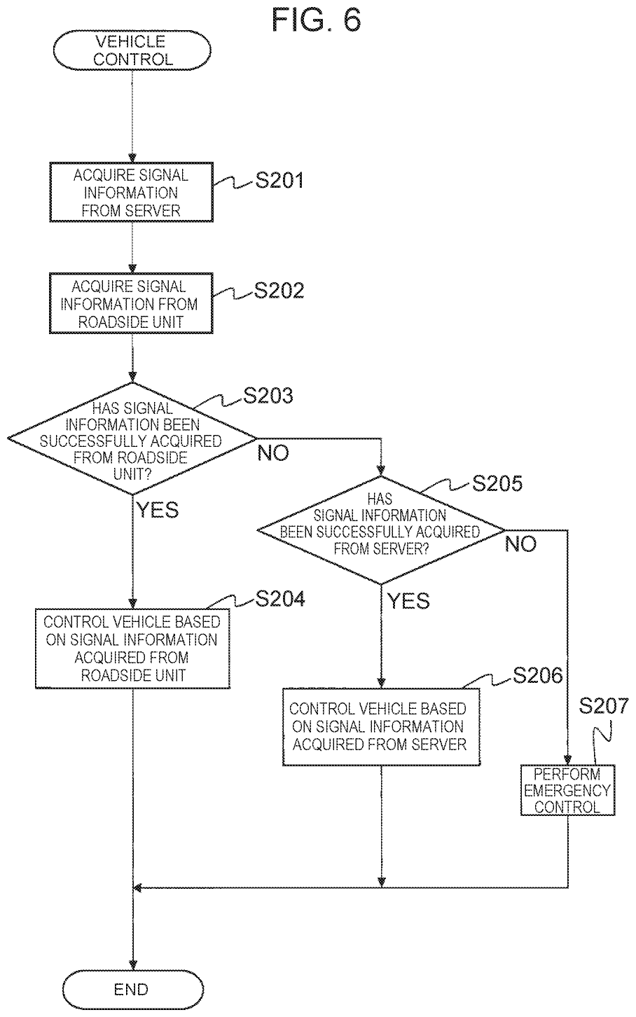

FIG. 6 is a flowchart showing a control routine of a vehicle control in the second embodiment. The control routine is repeatedly executed by the ECU 90.

First, in step S201, similarly to step S101 in FIG. 4, the signal information acquisition unit 96 acquires the signal information about at least one traffic light from the server 2. Next, in step S202, the signal information acquisition unit 96 acquires the signal information about the traffic light from the roadside unit 83 by the road-vehicle communication.

Next, in step S203, the vehicle control unit 97 determines whether the signal information acquisition unit 96 has successfully acquired the signal information from the roadside unit 83. For example, in the case where the signal information has been sent from the roadside unit 83 to the vehicle 3 before the distance between the vehicle 3 and the forward traffic light becomes equal to or less than a predetermined value, the vehicle control unit 97 determines that the signal information acquisition unit 96 has successfully acquired the signal information from the roadside unit 83. On the other hand, in the case where the signal information has not been sent from the roadside unit 83 to the vehicle 3 when the distance between the vehicle 3 and the forward traffic light becomes equal to or less than the predetermined value, the vehicle control unit 97 determines that the signal information acquisition unit 96 has failed to acquire the signal information from the roadside unit 83.

In the case where the vehicle control unit 97 determines that the signal information acquisition unit 96 has successfully acquired the signal information from the roadside unit 83 in step S203, the control routine proceeds to step S204. In step S204, the vehicle control unit 97 controls the vehicle 3, based on the information acquired from the roadside unit 83 by the signal information acquisition unit 96. For example, in the case where the lighting state of the traffic light is green, the vehicle control unit 97 controls the vehicle 3 such that the vehicle 3 passes through the traffic light. On the other hand, in the case where the lighting state of the traffic light is red, the vehicle control unit 97 controls the vehicle 3 such that the vehicle 3 stops at the traffic light. After step S204, the control routine ends.

On the other hand, in the case where the vehicle control unit 97 determines that the signal information acquisition unit 96 has failed to acquire the signal information from the roadside unit 83 in step S203, the control routine proceeds to step S205. In step S205, the vehicle control unit 97 determines whether the signal information acquisition unit 96 has successfully acquired the signal information from the server 2. In the case where the signal information acquisition unit 96 has successfully received the signal information from the server 2, the vehicle control unit 97 determines that the signal information acquisition unit 96 has successfully acquired the signal information from the server 2, and in the case where the signal information acquisition unit 96 has failed to receive the signal information from the server 2, the vehicle control unit 97 determines that the signal information acquisition unit 96 has failed to acquire the signal information from the server 2.

In the case where the vehicle control unit 97 determines that the signal information acquisition unit 96 has successfully acquired the signal information from the server 2 in step S205, the control routine proceeds to step S206. In step S206, similarly to step S102 in FIG. 4, the vehicle control unit 97 controls the vehicle 3, based on the signal information acquired from the server 2 by the signal information acquisition unit 96. After step S206, the control routine ends.

On the other hand, in the case where the vehicle control unit 97 determines that the signal information acquisition unit 96 has failed to acquire the signal information from the server 2 in step S205, the control routine proceeds to step S207. In step S207, the vehicle control unit 97 performs an emergency control. For example, the vehicle control unit 97 stops the vehicle 3 at a road shoulder for securing safety of the vehicle 3. After step S207, the control routine ends.

In the control routine, the position of step S203 and step S204 and the position of step S205 and step S206 may be swapped. That is, in the case where the signal information acquisition unit 96 has failed to acquire the signal information from the server 2, the vehicle control unit 97 may control the vehicle 3, based on the signal information acquired from the roadside unit 83 by the signal information acquisition unit 96. Thereby, even in the case of occurrence of an abnormal incident such as a failure of the communication network 5, it is possible to acquire the signal information from the roadside unit 83.

### Third Embodiment

The configuration and control of a control device for a vehicle and an automatic driving system according to a third embodiment are basically the same as the configuration and control in the first embodiment, except the following description. Therefore, for the third embodiment of the present disclosure, differences from the first embodiment will be mainly described below.

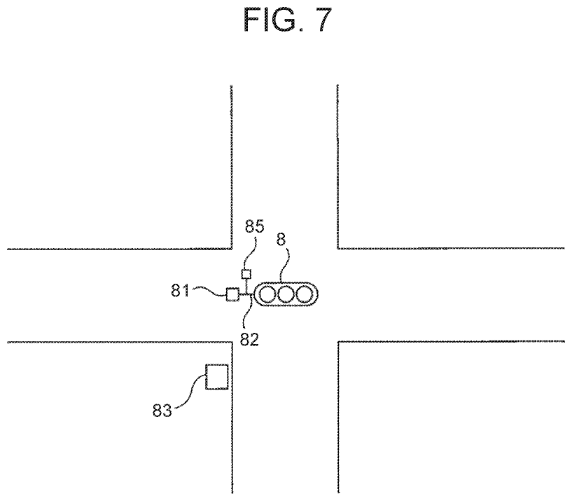

FIG. 7 is a diagram schematically showing a situation at an intersection in the third embodiment. In the third embodiment, a lighting state detector 85 is connected to the signal line 82 between the controller 81 and the traffic light 8. The lighting state detector 85 is provided at each traffic light 8, and detects the lighting state of the traffic light 8 from the signal line 82. The lighting state detector 85 includes a transceiver, and can communicate with the server 2. As the signal information about the traffic light 8, the lighting state detector 85 sends the lighting state of the traffic light 8 to the server 2 through the wireless base station 6 and the communication network 5.

The signal line 82 includes a line for transmitting a control signal of the traffic light 8 that is sent from the controller 81, and an output circuit for supplying electricity to the traffic light 8 based on the control signal. For example, the lighting state detector 85 detects the lighting state of the traffic light 8, by detecting the control signal from the signal line 82. The lighting state detector 85 may detect the lighting state of the traffic light 8, by detecting the electricity to be supplied to the traffic light 8, from the signal line 82.

In the third embodiment, the server 2 acquires the signal information about a plurality of traffic lights 8, from the lighting state detectors 85 respectively provided at the traffic lights 8, instead of the traffic control center 7. Thereby, even when the traffic control center 7 does not perform the central control of the traffic lights 8, it is possible to acquire the signal information about the traffic lights 8.

The lighting state detectors 85 may send the signal information about the traffic lights 8 to the roadside units 83, and the server 2 may acquire the signal information about the traffic lights 8 from the lighting state detectors 85 through the roadside units 83. Further, the server 2 may acquire the signal information about a plurality of traffic lights 8, from the controllers 81 respectively provided at intersections. The controllers 81 may send the signal information about the traffic lights 8 to the roadside units 83, and the server 2 may acquire the signal information about the traffic lights 8 from the controllers 81 through the roadside units 83.

Embodiments according to the present disclosure have been described above. An applicable embodiment of the present disclosure is not limited to the embodiments, and various modifications and alterations can be made within the scope described in the embodiments described above.

For example, in the first embodiment, the server 2 may acquire the signal information about a plurality of traffic lights 8, from the traffic light images generated by the cameras, similarly to the second embodiment. Further, in the first embodiment, the server 2 may acquire the signal information about a plurality of traffic lights 8, from the controllers 81 or the lighting state detectors 85, similarly to the third embodiment. Further, in the second embodiment, the server 2 may acquire the signal information about a plurality of traffic lights 8, from the traffic control center 7, similarly to the first embodiment. Further, in the second embodiment, the server 2 may acquire the signal information about a plurality of traffic lights 8, from the controllers 81 or the lighting state detectors 85, similarly to the third embodiment.

Further, in the first embodiment or the second embodiment, the server 2 may acquire the signal information about a plurality of traffic lights 8, from the traffic light images generated by the cameras and the traffic control center 7. Further, in the first embodiment or the second embodiment, the server 2 may acquire the signal information about a plurality of traffic lights 8, from the traffic light images generated by the cameras, the traffic control center 7 and the controllers 81 or the lighting state detectors 85.

Further, the traffic information acquisition unit 96 may acquire the signal information about the forward traffic light, from the traffic light image generated by the exterior camera 321 that is provided on the own vehicle 3. In this case, in step S207 in FIG. 6, the vehicle control unit 97 may control the vehicle 3, based on the signal information acquired from the traffic light image generated by the exterior camera 321 that is provided by the own vehicle 3.

The vehicle 3 may be used for a mobility service (a car sharing service, a ride sharing service or the like) that transports a passenger to a destination in response to a vehicle dispatch request.

What is claimed is:

1. A control device for a vehicle, the vehicle performing autonomous traveling, the control device comprising:
a signal information acquisition unit that acquires signal information about at least one traffic light, from a server having signal information about a plurality of traffic lights provided at a plurality of intersections; and
a vehicle control unit that controls the vehicle, based on the signal information acquired by the signal information acquisition unit.

2. The control device for the vehicle according to claim 1, wherein the signal information acquisition unit sends a position of the vehicle and a movement direction of the vehicle, to the server, and acquires signal information about a traffic light that is positioned forward of the vehicle and that is closest to the vehicle, from the server.

3. The control device for the vehicle according to claim 1, wherein the signal information acquisition unit acquires future signal information about at least one traffic light, from the server.

4. The control device for the vehicle according to claim 1, wherein the signal information acquisition unit acquires signal information about a plurality of traffic lights, from the server.

5. The control device for the vehicle according to claim 3, wherein:
the signal information acquisition unit acquires future signal information about a plurality of traffic lights on a traveling route of the vehicle, from the server; and
the vehicle control unit controls a speed of the vehicle, based on the future signal information about the plurality of traffic lights.

6. The control device for the vehicle according to claim 3, wherein:
the signal information acquisition unit acquires future signal information about a plurality of traffic lights for each of which a distance from the vehicle is equal to or less than a predetermined value, from the server; and
the vehicle control unit resets a traveling route of the vehicle, based on the future signal information about the plurality of traffic lights.

7. The control device for the vehicle according to claim 1, wherein:
the signal information acquisition unit acquires signal information about a traffic light from a roadside unit by road-vehicle communication; and
when the signal information acquisition unit fails to acquire the signal information from the roadside unit, the vehicle control unit controls the vehicle, based on the signal information acquired from the server by the signal information acquisition unit.

8. The control device for the vehicle according to claim 1, wherein:
the signal information acquisition unit acquires signal information about a traffic light from a roadside unit by road-vehicle communication; and
when the signal information acquisition unit fails to acquire the signal information from the server, the vehicle control unit controls the vehicle, based on the signal information acquired from the roadside unit by the signal information acquisition unit.

9. An automatic driving system comprising:
a server that acquires signal information about a plurality of traffic lights provided at a plurality of intersections;
a signal information acquisition unit that acquires signal information about at least one traffic light, from the server; and
a vehicle control unit that controls a vehicle, based on the signal information acquired by the signal information acquisition unit.

10. The automatic driving system according to claim 9, wherein the server acquires the signal information about the plurality of traffic lights, from a traffic control center that generates control information about traffic lights.

11. The automatic driving system according to claim 9, wherein the server acquires the signal information about the plurality of traffic lights, from traffic light images that are generated by cameras.

12. The automatic driving system according to claim 9, wherein the server acquires the signal information about the plurality of traffic lights, from controllers or lighting state detectors, each of the controllers controlling a lighting state of the traffic light, each of the lighting state detectors detecting the lighting state of the traffic light from a signal line between the traffic light and the controller.
